(19) United States
(12) Patent Application Publication
(10) Pub. No.: US 2008/0280278 A1
(43) Pub. Date: Nov. 13, 2008

(54) Method and Apparatus for Affecting Behavioral Patterns of a Child

(75) Inventors: In-Lung Chu, Taipei (TW); Hao-Hua Chu, Taipei (TW)

Correspondence Address: GENE I. SU, XIN YI RD., SECTION 4, NO. 151, 17F-1, TAIPEI, TW

(73) Assignee: RAINDROP NETWORK LTD., Taipei (TW)

(21) Appl. No.: 11/839,555

(22) Filed: Aug. 16, 2007

(30) Foreign Application Priority Data
May 10, 2007 (TW) 096116643

(51) Int. Cl. G09B 1/00; G09B 19/00

(52) U.S. Cl. 434/238

(57) ABSTRACT

A method and apparatus for affecting behavioral patterns of a child are disclosed. Specifically, one embodiment of the present invention sets forth a method, which includes the steps of determining a behavioral pattern of a child based on a set of detected data while the child performs acts associated with the behavioral pattern, comparing the behavioral pattern against a first set of expected conditions to generate a comparison result, and generating a reward for the child based on the comparison result, wherein the reward affects the behavioral pattern.

### BACKGROUND OF THE INVENTION

1. Field of the Invention

The present invention relates generally to interactive devices, especially a device capable of modifying behavioral patterns of a child.

2. Description of the Related Art

During a child's growth period, the child usually develops various undesirable behavioral patterns, which need to be corrected in time to avoid lasting effects. With the help of appropriate auxiliary tools, some desired results can be achieved in half of the usual amount of time needed. For example, a food-serving tray with gaming capabilities can attract the attention of a child by appealing to his/her curiosity and interest when he/she eats; therefore, the parents of the child can use the food-serving tray to encourage the child to develop proper eating behavior.

FIG. 1 illustrates a conventional food-serving tray with gaming capabilities. The food-serving tray includes a behavior modification game designed to help improve the eating behavior of a child. A food-serving tray 100 is divided into 6 sections—102, 104, 106, 108, 110, and 112. A food container can be placed on top of each of the sections 102, 104, 106, 108, and 110. Section 112 consists of a figure of a cartoon character. Underneath each of the sections 102, 104, 106, 108, and 110 is a sensor, which is used to detect the weight of the food on top of each of the sections. Each of the sections 102, 104, 106, 108, and 110 corresponds to a specific part of the cartoon character in section 112 (i.e. head, hand, feet, etc.) When the weight of the food decreases for a certain section, the part of the cartoon character corresponding to that certain section is colored.

According to this conventional food-serving tray, for example, during meal time, when the food on top of the section 102 is consumed, the consumption causes the weight of the food to decrease. When the weight decreases, the part of the cartoon character (i.e. the head) corresponding to the section 102 is then colored. When the food consumption is finished in all sections, the coloring of the entire cartoon character is also then completed. Using a behavior modification game such as the coloring of a cartoon character may give incentives to a child to eat properly.

However, such a conventional food-serving tray with gaming capabilities has several notable shortcomings. One, since a sensor needs to be installed underneath each section in this food-serving tray, the structural complexity and also the cost of manufacturing such a food-serving tray is increased. Two, it is possible that the user could lose interest in the game after a certain time period, because only one kind of game exists on the food-serving tray, and the sections correspond to the specific areas of the cartoon character are always the same. The lost of interest could lessen the effectiveness of the food-serving tray and therefore decrease the effect it would have on the eating behavior of the child.

Moreover, the game in the aforementioned food-serving tray is only programmed to respond to feedback from the sensors. It lacks any intelligence to decipher how the feedback relates to the behavior of the child. For example, if the child misbehaves and deliberately throws food away, then the detected weight still decreases, causing the coloring of the cartoon character. In other words, the child is wrongly encouraged, so to speak, to misbehave even further.

As the foregoing illustrates, what is needed is a way to intelligently modify the behavioral patterns of a child and address at least the problems set forth above.

### SUMMARY OF THE INVENTION

A method and apparatus for affecting behavioral patterns of a child are disclosed. Specifically, one embodiment of the present invention sets forth a method, which includes the steps of determining a behavioral pattern of a child based on a set of detected data while the child performs acts associated with the behavioral pattern, comparing the behavioral pattern against a first set of expected conditions to generate a comparison result, and generating a reward for the child based on the comparison result, wherein the reward affects the behavioral pattern.

One advantage of the disclosed method and apparatus is the ability to use the behavioral pattern of a child as the input to an application, in which the behavioral pattern can be affected in an intelligent and cost effective manner.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a conventional food-serving tray with gaming capabilities;

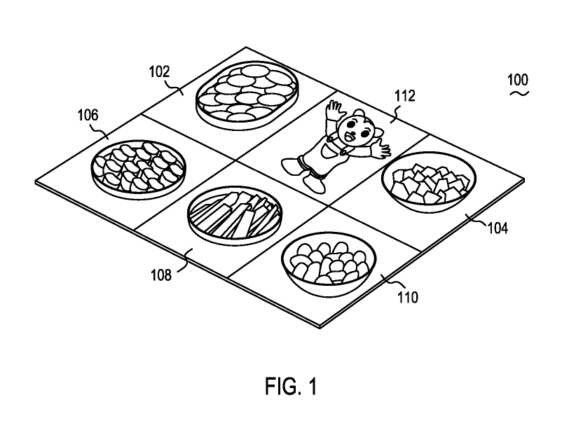

FIG. 2 illustrates an assistive eating device, according to one embodiment of the present invention;

FIG. 3A illustrates a snapshot of the output of a behavior modification game operating on an assistive eating device, according to one embodiment of the present invention;

FIG. 3B illustrates another snapshot of the output of the same behavior modification game operating on an assistive eating device, according to one embodiment of the present invention;

FIG. 4 is a conceptual diagram of a child receiving rewards from a behavior modification game, according to one embodiment of the present invention;

FIG. 5A is another assistive eating device configured to utilize a behavior modification game, according to another embodiment of the present invention;

FIG. 5B is yet another assistive eating device configured to utilize a behavior modification game, according to another embodiment of the present invention; and

FIG. 6 is a flow chart demonstrating the method steps performed by an assistive eating device, according to one embodiment of the present invention.

### DETAILED DESCRIPTION

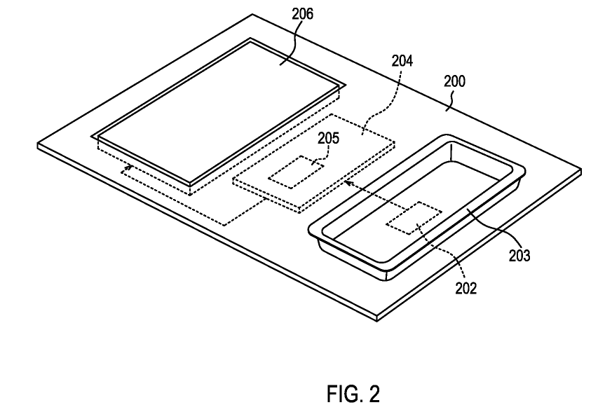

FIG. 2 illustrates an assistive eating device, according to one embodiment of the present invention. The assistive eating device 200 includes a sensor 202, a processing unit 204, and a display unit 206. The assistive eating device 200 includes a food container 203, with the sensor 202 located underneath the container 203 to detect weight changes in a preset time interval. The processing unit 204 executes the instructions for an application and receives the detected weight changes from the sensor 202. According to the different detected weight change information, a different application may be invoked and executed. The display unit 206 is also connected to the processing unit 204 and is used to display certain output of the application. Some examples of the display unit 206 include, without limitation, a flat panel display (e.g., a liquid crystal display, a liquid crystal on silicon display, and an organic light-emitting diode-based display). In one implementation, the display unit 206 also includes a touch screen as a user interface. The processing unit 204 also includes a memory unit 205 to store the instructions of the applications. The processing unit 204 can be a microprocessor. In an alternative embodiment, the memory unit 205 can be an external memory module of the processing unit 204, such as, without limitation, a flash memory card and an external hard drive, to store the instructions of the application to be executed by the processing unit 204.

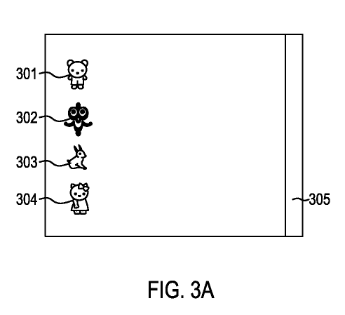

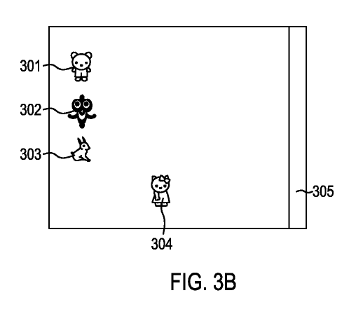

To further illustrate one embodiment of the present invention, an example using an application providing a competitive and behavior modification game is shown in FIG. 3A and 3B. In FIG. 3A, the display unit 206 of the assistive eating device 200 displays the beginning frame of the behavior modification game. Characters 301˜304 displayed on the display unit 206 represent the multiple contestants in the game, and these contestants are manipulated by the application to move toward a finish line 305.

When the game begins, a user of the assistive eating device 200 can choose from characters 301˜304 to represent the user. For instance, the child can pick the character 301, and the other users, such as the parents of the child or other children (e.g., from the same household or from another household in another family), can pick from the remaining characters. The game is designed so that it is more fun if there are more participants. Additional details are discussed in subsequent paragraphs.

Initially, the assistive eating device 200 in FIG. 2 has the empty container 203 on top of the sensor 202. In one implementation, the assistive eating device 200 goes through a calibration process in which the sensor 202 measures the weight of the empty container 203. When food is added to the container 203, the sensor 202 then detects the weight of the container 203 with the added food and feeds this information to the processing unit 204. The processing unit 204 can subtract the weight of the empty container 203 from the newly detected weight to obtain the weight of the food in the container 203. In addition, the sensor 202 is programmed to detect the weight in a pre-set time interval. The time interval can vary according to different conditions.

In one implementation, whenever the weight of the food in the container 203 decreases, the application, randomly or according to a predetermined sequence, selects a character from the characters 301˜304 shown in FIG. 3A and moves it a step closer to the finish line 305. At the end of the game, the character closest to the finish line 305 is declared the winner.

In another implementation, after the assistive eating device 200 has been activated for a period of time, such as 1-2 seconds to allow the sensor 202 to stabilize, if the weight of the food in the container 203 is determined to have decreased during this time period after the activation, then the application randomly or according to a predetermined sequence selects a character from characters 301˜304 and moves the character a step closer to the finish line 305. In the illustrated example in FIG. 3b, the character 304 is selected. In an intermittent reward system, however, the selected character may not advance every time the weight decreases. The theory behind such a system is that partial reinforcement (e.g., advancing a character intermittently) is far more effective than constant and repeating reinforcement.

It should be apparent to a person with ordinary skills in the art to use any external display unit, such as a television and a monitor, as the display unit 206 and couple such an external display unit to the assistive eating device 200 via a wired connection. Alternatively, the display unit of any wireless electronic equipment, such as a personal digital assistant (PDA), a mobile phone, and a laptop, can also serve as the display unit 206 and couple to the assistive eating device 200 through a wireless connection. Some examples of such a wireless connection are, without limitation, Bluetooth and Wi-Fi. If the display unit 206 is placed external to the assistive eating device 200, then the design and structure of the assistive eating device 200 may be simplified, resulting in a reduction in the manufacturing cost of such a device.

Additionally, to maintain a high interest level of the user of the assistive eating device 200, a different game can be selected and played per session. In other words, the memory unit 205 can store and also allow different games to be played back. Also, the games stored in the memory unit 205 can be updated through an external device. Such an external device can be, without limitation, a memory card, a memory stick, and an external hard drive that directly attaches to the assistive eating device 200. Alternatively, this external device is on the Internet and couples to the assistive eating device 200 via a network connection. In yet another embodiment, multiple assistive eating devices are connected through a network, such as the Internet, so that the users of these devices (even at different physical locations) are able to participate, compete, or even communicate with one another in the same game.

It is worth noting that a weight decrease for the food in the container 203 does not necessarily mean the child is eating the food. The child may play with the food, pick up and then put back down the food, or simply throw away food. In one implementation, the application (e.g., the game) is not activated unless the weight decrease is indeed attributed to the child actually eating the food. Thus, using the game described above and shown in FIG. 3A and FIG. 3B, only if the child indeed eats a portion of the food in the container 203, then the selected character will move closer to the finish line 305.

Also, since the sensor 202 is underneath the container 203 in one implementation, if the container 203 ever falls off the assistive eating device 200, then the sensor 202 will not be able to gather the needed information correctly. This causes the application to function improperly, because it lacks any feedback information associated with the weight of the food in the container 203 to process. To prevent such a problem from occurring, in one implementation, the container 203 can be affixed onto the assistive eating device 200. When the container 203 needs to be cleaned, the container can be removed from the assistive eating device 200 and then again affixed onto the device after the cleaning. In addition, because the sensor 202 likely covers a certain sensor area in which it is able to detect weight information, the sensor 202 may pick up false weight information, such as objects that are wrongly placed inside this sensor area or the user's physical touching of the sensor area, and cause the application to operate improperly. To avoid such interference problems, in one implementation, the sensor area of the senor 202 should be no larger than the bottom area of the container 203.

Some examples of the assistive eating device 200 include, without limitation, a food-serving tray or a placemat. The materials suitable for such a placemat, in one implementation, have characteristics such as waterproofing and elasticity so that the placemat can be easily cleaned and carried. The placemat may include a case that houses contain all the electronic parts, and the case fits into this placemat. Also, the placemat can be in a number of different shapes and can also include well-known characters.

Some additional operational details of one embodiment of the assistive eating device 200 are discussed below. One, if a predetermined condition is reached, a character in the game can be randomly selected and moved towards the finish line. Then, the character closest to the finish line is declared the winner. This random selection of a character prevents such a game from having the same character as the winner and thus avoids boring the player of the game. It should be apparent to a person with ordinary skills in the art to recognize that the racing game is only one of many applications that can be operated in the assistive eating device 200. Two, each time the sensor 202 is activated, if the current weight of the food detected by the sensor 202 is smaller than the previous detected weight, then the application may be activated to operate on the assistive eating device 200. Three, a single sensor may be sufficient for the assistive eating device 200, and the display unit 206 may be a part of an external device, which is connected to the assistive eating device 200. In such a configuration, the design and the structure of the assistive eating device 200 is simplified, and the cost of manufacturing the device is also reduced. Lastly, the memory unit 205 is capable of storing multiple applications for the user of the assistive eating device 200 to choose from and as a result making the assistive eating device more interesting to the user.

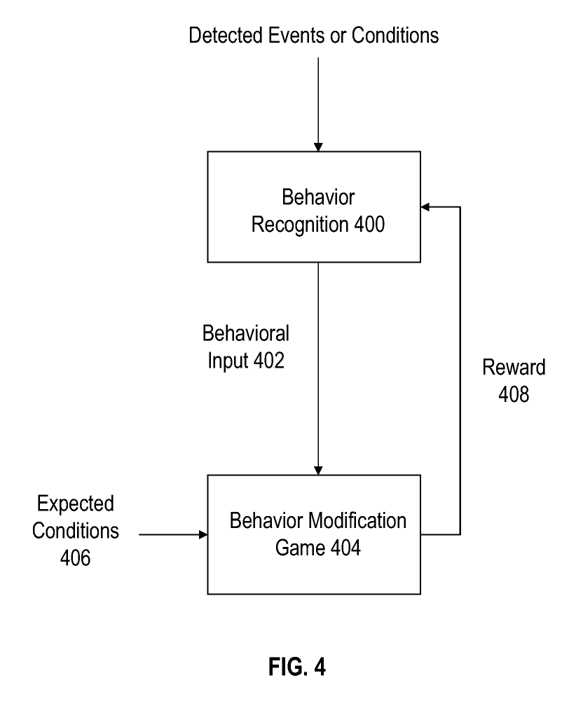

FIG. 4 is a conceptual diagram of a child receiving rewards from a behavior modification game 404, according to one embodiment of the present invention. In one implementation, suppose the behavior modification game 404 corresponds to the application that the assistive eating device 200 of FIG. 2 executes, and a child is eating food from the container 203 of the assistive eating device 200. The behavior modification game 404 is configured with certain expected conditions 406, such as the magnitude of weight decrease attributable to the child consuming food from the container 203, by an administrator of the game, who is usually a person looking after the child. In addition, the behavior modification game 404 is configured to receive behavioral input 402 from a behavior recognition block 400. The behavior recognition block 400 derives the behavioral input 402 from events or conditions detected by the assistive eating device 200, after filtering out the noises associated with such events or conditions (e.g., the child throwing food away).

To encourage certain behavioral development for the child, the behavior modification game 404 processes the behavioral input 402 from the child and issues a reward 408 to the child if a threshold number of expected conditions 406 are met. For example, the parents of the child pre-program the game of a set of expected conditions 406, such as eating all the food from the container 203 within 30 minutes, into the game. If the behavioral input 402 is determined to match the parents' desired behavior (i.e., finishing food within a reasonable amount of time), then the behavior modification game 404 issues the reward 408, such as a positive reward (e.g., advancing the character mentioned above a step closer to the finish line), to the child to encourage the child to continue the behavior. Alternatively, the reward 408 can be a negative reward (e.g. retreating a step away from the finish line or showing tiredness or exhaustiveness for the character) or a neutral award (e.g., keeping the character still) to discourage the child from continuing his or her actions.

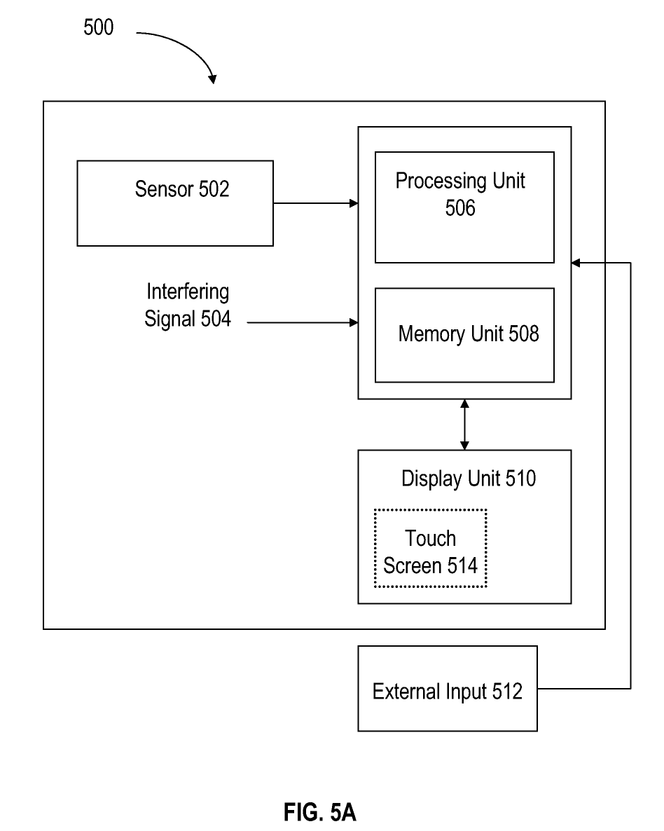

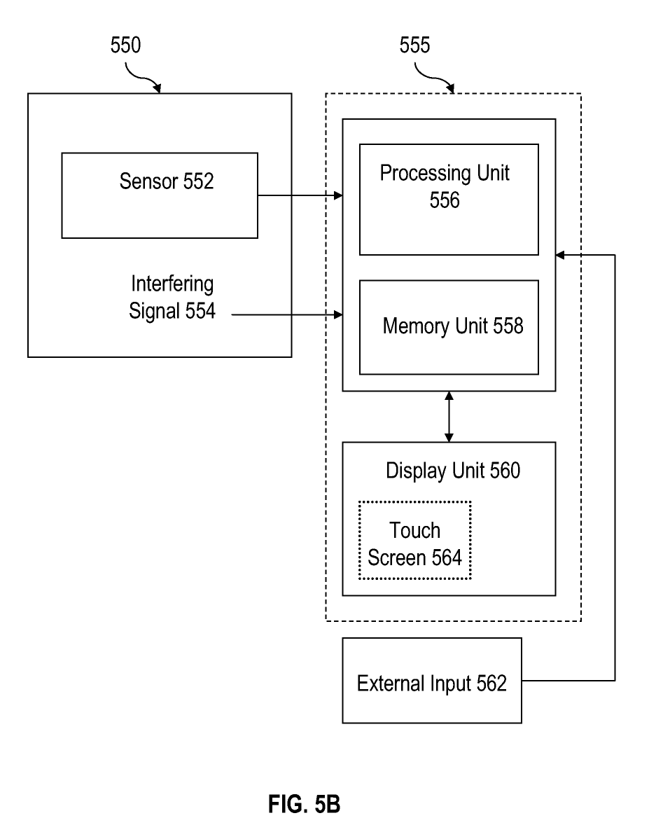

FIG. 5A is an assistive eating device 500 configured to utilize a behavior modification game, according to another embodiment of the present invention. The assistive eating device 500 includes a sensor 502, a processing unit 506, a memory unit 508, a display unit 510, and an external input 512. The sensor 502 is configured to detect characteristics information, such as weight, of any object within the detection range of the sensor 502. The processing unit 506 receives the detected characteristics information from the sensor 502. The processing unit 506 is configured to process the information, such as filtering out certain noises, and compare the information to the expected conditions stored in the memory unit 508. As mentioned above, these expected conditions generally correspond to desired behavioral patterns. The display unit 510 is used to display the output of the application operating on the assistive eating device 500. The external input 512 is an interface enabling any desired condition to be programmed into the memory unit 508. Some examples of the external input 512 include, without limitation, a wired connection, such as a Universal Serial Bus (USB) connection and an IEEE1394 cable, and a wireless connection, such as Bluetooth and Wi-Fi connection. Since one of the purposes of the assistive eating device 500 is to assist the user of the device develop certain desired behavioral patterns, different expected conditions may need to programmed into the device at different times to achieve such a purpose. In one implementation, a touch screen 514 of the display unit 510 can serve as a user interface, enabling the user to input program commands to the assistive eating device 500. When unexpected or undesired conditions occur, the interfering signal 504 is used to reset or reboot the assistive eating device 500 and return it back to its default state.

FIG. 5B is yet another assistive eating device 550 also configured to utilize a behavior modification game, according to another embodiment of the present invention. Unlike the assistive eating device 500, here, the assistive eating device 550 is an accessory to a mobile device 555, which includes its own processing unit 556, a memory unit 558, and a display unit 560. In other words, the expected conditions for the behavior modification game are programmed into the mobile device 555 via an external input 562; the behavior modification game is executed by the processing unit 556 of the mobile device 555; and the output of the behavior modification game is displayed on the display unit 560 of the mobile device 555.

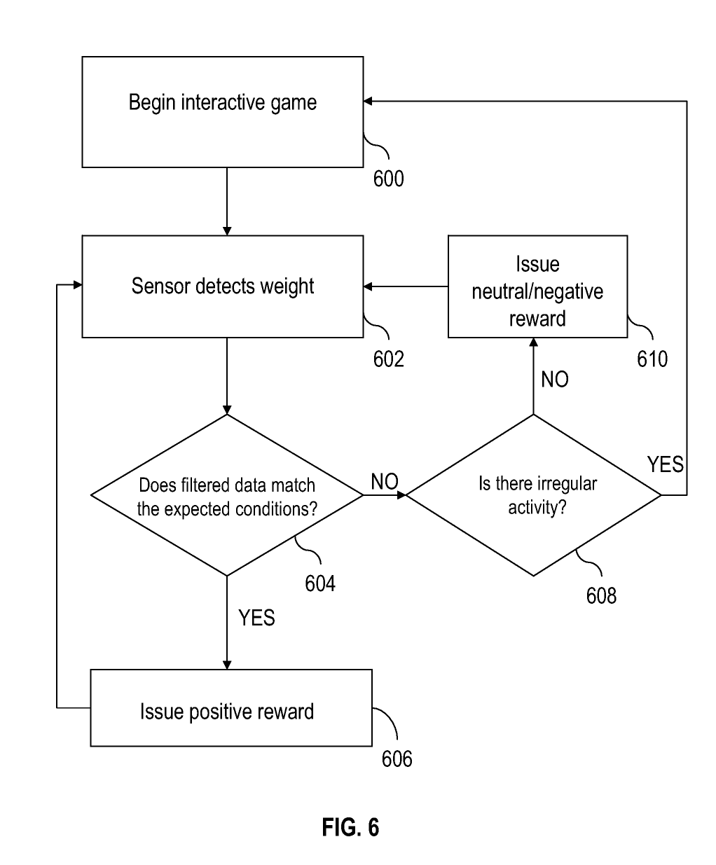

To further illustrate how the assistive eating device 500 operates, FIG. 6 is a flow chart demonstrating the method steps performed by the assistive eating device 500, according to one embodiment of the present invention. Suppose here the assistive eating device 500 is a food-serving tray for a child, and suppose further that the expected conditions are for the child to consume the food he or she picks up from the container each time. Before providing the container to the child, the parents can program such expected conditions into the memory unit 508 through the external input 512. Also, suppose the application to be operated on the food-serving tray is an behavior modification game.

In conjunction with FIG. 5, after the behavior modification game begins operating in step 600, the sensor 502 starts measuring the weight of the container placed on the senor 502. Whenever the child picks up food from the container, the weight of the container changes. The processing unit 506 is configured to then decipher the weight information collected by the sensor 502, filter out noises (e.g., the child simply throwing away food that he or she picks up), and compare the filtered data with the expected condition stored in the memory unit 508 to decide whether rewards should be issued to the child in step 604. If the filtered data indeed matches the expected conditions (e.g., the child actually consumed the food he or she picked up), then the processing unit 506 causes positive rewards to be issued to the child in step 606. On the other hand, if the parents instead detect irregular actions in step 608, such as the child refusing to listen and simply throwing away food or purposely eating faster (e.g., without chewing) to obtain the rewards, one implementation of the assistive eating device 500 provides the parents with the option to input the interfering signal 504. The interfering signal 504 causes the processing unit 506 to stop or restart the behavior modification game running on the assistive eating device 500 in step 600. Such an abrupt action helps the parents reemphasize to the child the importance of having proper eating habits. Upon the discretion of the parents, if the child does not intentionally misbehave but still nevertheless fail to match the expected conditions, then the processing unit 506 causes negative or neutral rewards to be issued to the child in step 610.

The above description illustrates various embodiments of the present invention along with examples of how aspects of the present invention may be implemented. Some aspects of the present invention may be implemented as a program product for use with a device. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. The above examples, embodiments, instruction semantics, and drawings should not be deemed to be the only embodiments, and are presented to illustrate the flexibility and advantages of the present invention as defined by the following claims.

We claim:

1. An assistive eating device, comprising:
a container to store food;
a sensor to detect the weight of the container; and
a processing unit configured to calculate a first weight change associated with the container and execute an application according to a condition associated with the first weight change; and
a display unit to display the output of the application.

2. The assistive eating device of claim 1, wherein the application is a behavior modification game that manages a plurality of characters to move towards a finish line and displays the plurality of characters on the display unit.

3. The assistive eating device of claim 1, wherein the condition requires the first weight change to be less than any of previously calculated weight changes.

4. The assistive eating device of claim 1, wherein the sensor area of the sensor is sufficiently large to accommodate the bottom area of the container but sufficiently small to avoid picking up interference signals.

5. An assistive eating device for a child, comprising:
a processing unit configured to
determine a behavioral pattern for the child based on a set of detected data while the child interacts with the assistive eating device,
compare the behavioral pattern against a first set of expected conditions to generate a comparison result, and
generate a reward for the child based on the comparison result, wherein the reward affects the behavioral pattern.

6. The assistive eating device of claim 5, wherein the processing unit is further configured to filter out noises associated with the set of detected data to derive the behavioral pattern.

7. The assistive eating device of claim 5, wherein the processing unit is further configured to restart in response to an interfering signal triggered by an irregular activity.

8. The assistive eating device of claim 5, wherein the processing unit is further configured to operate on a second set of expected conditions received from an external input coupled to the assistive eating device.

9. The assistive eating device of claim 5, further comprising a memory unit to store a plurality of applications, each including a sequence of instructions, which when executed by the processing unit, causes the processing unit to issue the reward to the child.

10. The assistive eating device of claim 9, wherein one of the plurality of applications is a behavior modification game, wherein the reward induces a response from the child.

11. The assistive eating device of claim 9, further comprising a display unit to display the reward.

12. The assistive eating device of claim 9, wherein the processing unit executes the sequence of instructions for one of the plurality of applications, causes the processing unit to send the reward to an external device coupled to the processing unit to display.

13. The assistive eating device of claim 5, wherein the reward is intended to encourage the behavioral pattern.

14. The assistive eating device of claim 5, wherein the reward is intended to discourage the behavior pattern.

15. A method, comprising:
determining a behavioral pattern of a child based on a set of detected data while the child performs acts associated with the behavioral pattern,
comparing the behavioral pattern against a first set of expected conditions to generate a comparison result, and
generating a reward for the child based on the comparison result, wherein the reward affects the behavioral pattern.

16. The method of claim 15, wherein the determining step further includes filtering out noises associated with the set of detected data to derive the behavioral pattern.

17. The method of claim 15, further comprising restarting the determining step in response to an interfering signal triggered by an irregular activity.

18. The method of claim 15, further comprising reprogramming the first set of expected conditions with a second set of expected conditions before generating the comparison result.

19. The method of claim 15, further comprising selecting from a plurality of applications, each capable of generating the reward for the child.

20. The method of claim 19, wherein one of the plurality of applications is a behavior modification game, wherein the reward induces a response from the child.

21. The method of claim 19, further comprising displaying the reward.

22. An assistive eating device for a child, comprising:
a sensor to generate a set of detected data while the child interacts with the assistive eating device, and
an interface to couple to a mobile device, wherein the mobile device includes a processing unit that is configured to:
determine a behavioral pattern for the child based on the set of detected data;
compare the behavioral pattern against a first set of expected conditions to generate a comparison result, and
generate a reward for the child based on the comparison result, wherein the reward affects the behavioral pattern.

23. The assistive eating device of claim 22, wherein the processing unit of the mobile device is further configured to filter out noises associated with the set of detected data to derive the behavioral pattern.

24. The assistive eating device of claim 22, wherein the processing unit of the mobile device is further configured to operate on a second set of expected conditions received from an external input coupled to the assistive eating device.

25. The assistive eating device of claim 22, wherein the mobile device further includes a memory unit to store a plurality of applications, each including a sequence of instructions, which when executed by the processing unit, causes the processing unit to issue the reward to the child.

26. The assistive eating device of claim 25, wherein one of the plurality of applications is a behavior modification game, wherein the reward induces a response from the child.

27. The assistive eating device of claim 25, wherein the mobile device further includes a display unit to display the reward.
